(19) United States
(12) Patent Application Publication
(10) Pub. No.: US 2020/0339320 A1
(43) Pub. Date: Oct. 29, 2020

(54) CHILD-RESISTANT SINGLE WALL SQUEEZE AND TURN CLOSURE AND CONTAINER ASSEMBLY

(71) Applicant: Drug Plastics & Glass Company, Inc., Boyertown, PA (US)

(72) Inventors: Frederick N. BIESECKER, II, Boyertown, PA (US); Nathaniel KOLLER, Boyertown, PA (US); Bruce T. CLEEVELY, Boyertown, PA (US); Douglas S. CAMOMILE, Boyertown, PA (US); Lissa BIESECKER LONGACRE, Boyertown, PA (US); Joshua T. KOEHLER, Boyertown, PA (US)

(21) Appl. No.: 16/764,918

(22) PCT Filed: Nov. 20, 2018
(86) PCT No.: PCT/US18/62026

§ 371 Date: May 18, 2020

Related U.S. Application Data
(60) Provisional application No. 62/589,032, filed on Nov. 21, 2017.

(51) Int. Cl. B65D 50/04; B65D 51/24; A61J 1/03

(52) U.S. Cl. CPC B65D 50/046; A61J 1/03; B65D 51/245

(57) ABSTRACT

Child resistant closures are typically two-piece assemblies or squeeze and turn closures with an inside wall and an outside wall. The current squeeze and turn child resistant closures are expensive and difficult for seniors to operate. The preferred design is a child-resistant single wall cap and container assembly that is preferably easy for seniors to open and difficult for children to open or is substantially child-resistant. In addition, due to the single wall of the cap and relatively low cap height, the preferred assembly is light, requires less material and relatively less expensive to manufacture than prior art container assemblies. Like many child resistant closure systems, the preferred container assembly design includes a container with specifically designed neck finish to lock the closure on the container. However, the preferred design includes two small lugs, which generally do not add significantly to the bottle complexity or bottle cost.

### CROSS-REFERENCE TO RELATED APPLICATIONS

The present claims the benefit of U.S. Provisional Patent Application No. 62/589,032, filed on Nov. 21, 2017 and titled “Child-Resistant Single Wall Squeeze and Turn Closure and Container Assembly” the entire contents of which are incorporated herein by reference in its entirety.

### BACKGROUND OF THE INVENTION

Known child-resistant closures and container assemblies are typically constructed of two piece assemblies or squeeze and turn closures with an inside wall and an outside wall. The known squeeze and turn child-resistant closures are relatively expensive and can be difficult for seniors to operate. It is desirable to design, construct and implement a child-resistant closure and container assembly that addresses the shortcomings of known child-resistant closures and container assemblies.

### BRIEF SUMMARY OF THE INVENTION

The preferred design for a single wall child-resistant closure and container assembly is relatively easy for seniors to open and relatively difficult for children to open, or is child-resistant. The closure and container assembly provides an audible click assuring the user that the cap is secured and in a locked position relative to the container. In addition, due to the single wall, the closure and container assembly is relatively light, requiring less material and is relatively less expensive to manufacture when compared to known child-resistant closures and container assemblies. Like many child resistant closure systems the preferred closure design includes a bottle with specifically designed neck finish to lock the closure onto the bottle or container. This preferred child-resistant container assembly includes two small lugs extending outwardly from the neck of the container and inwardly from the skirt of the cap or closure, which do not add significantly to the bottle or closure complexity or to the bottle or closure cost.

In another aspect, the preferred invention is directed to a lightweight container assembly wherein an operator squeezes opposing sides toward a longitudinal axis to open the container assembly. The container assembly includes a cap having a top and a skirt extending substantially perpendicularly from the top. The skirt has a first bulge and a second bulge extending radially outwardly relative to the longitudinal axis. The first bulge is positioned opposite the second bulge on the skirt. The cap also includes first and second cap lugs extending inwardly from the skirt. The first cap lug is positioned opposite the second cap lug on the skirt and the first and second cap lugs are spaced from the first and second bulges. A container has a body and a narrowed neck extending from the body. The neck defines a mouth at a top end of the neck. The container includes first and second container lugs extending radially outwardly from the neck. The first container lug is positioned opposite the second container lug on the neck. The first and second cap lugs interact with the first and second container lugs to block backward or reverse rotation of the cap relative to the container in a locked configuration, wherein the cap is in a relaxed configuration. In addition to the first and second lugs, the cap has a secondary set of lugs also extending inwardly from the skirt that are intended to stop the cap from over-rotating when applied to the container. The container additionally has two rotation-stop lugs or flat vertical surfaces that extend radially outwardly from the neck. While the cap is in the locked configuration, the rotation-stop lugs located on the cap interact with the rotation-stop lugs or surfaces on the container to stop further forward rotation of the cap relative to the container, and thus prevent over-tightening of the cap on the container, which may cause the container assembly to inadvertently come out of the locked configuration.

In another aspect, the preferred invention is directed to a child resistant closure assembly for limiting access to contents that are positioned in a container of the closure in a locked configuration. The closure assembly includes a cap having a top and a skirt extending substantially perpendicularly from the top and the container having a body and a narrowed neck extending from the body. The skirt is substantially cylindrical and has a first bulge and a second bulge extending radially outwardly relative to a longitudinal axis. The first bulge is positioned opposite the second bulge on the skirt. The cap includes first and second cap lugs extending inwardly from the skirt. The first cap lug is positioned opposite the second cap lug on the skirt and the first and second cap lugs are spaced from the first and second bulges. The first and second cap lugs and the first and second bulges are positioned proximate a terminal end of the skirt. The cap includes cap threads extending inwardly from the skirt. The cap threads are positioned proximate the top. The first and second cap lugs include cap ramp surfaces, cap locking surfaces and cap lug peak surfaces. The neck of the container defines a mouth at a top end. The container includes first and second container lugs extending radially outwardly from the neck. The first container lug is positioned opposite the second container lug on the neck. The first and second container lugs are positioned proximate a shoulder of the container and are spaced from the mouth. The first and second container lugs include container ramp surfaces, container locking surfaces and container lug peak surfaces. The first and second cap lugs interact with the first and second container lugs to block pivoting of the cap relative to the container in a locked configuration when the cap is in a relaxed configuration. The cap locking surface of the first cap lug faces the container locking surface of the first container lug in the locked configuration. The container includes container threads extending from the neck proximate the mouth.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a top perspective view of a container assembly or closure assembly, including a cap and a container, in accordance with a preferred embodiment of the present invention;

FIG. 2 is a front elevational view of the container assembly of FIG. 1, wherein the cap is in a relaxed configuration;

FIG. 3 is a front elevational view of the container assembly of FIG. 1, wherein the cap is in a squeezed configuration;

FIG. 4 is a side elevational view of the container assembly of FIG. 1, wherein the cap is in the relaxed configuration;

FIG. 5 is a side elevational view of the container assembly of FIG. 1, wherein the cap is in a squeezed configuration;

FIG. 6 is a top plan view of the container assembly of FIG. 1, wherein the cap is in a relaxed configuration;

FIG. 7 is a cross-sectional view of the container assembly of FIG. 1, taken along line X-X of FIG. 6, wherein the cap and the container are positioned to show first and second container lugs;

FIG. 8 is a cross-sectional view of the container assembly of FIG. 1, taken along line X-X of FIG. 6, wherein the cap and the container are positioned to show first and second cap lugs;

FIG. 9 is a cross-sectional view of the container assembly of FIG. 1, taken along line Y-Y of FIG. 1;

FIG. 10 is a cross-sectional view of the container assembly of FIG. 1, taken along line Z-Z of FIG. 1, wherein the container assembly is in an unlocked configuration;

FIG. 11 is a magnified cross-sectional view of the container assembly of FIG. 1, taken from within portion 11 of FIG. 10;

FIG. 12 is a cross-sectional view of the container assembly of FIG. 1, taken along line Z-Z of FIG. 1, wherein the cap is pivoted relative to the container to engage cap ramp surfaces of the cap lugs with container ramp surfaces of the container lugs;

FIG. 13 is a cross-sectional view of the container assembly of FIG. 1, taken along line Z-Z of FIG. 1, wherein the cap is in a squeezed configuration and the cap is pivoted relative to the container such that cap lug peak surfaces of the cap and container lug peak surfaces of the container are positioned adjacent to each other with the cap lug peak surfaces being spaced radially outwardly relative to the container lug peak surfaces;

FIG. 14 is a magnified top perspective, cross-sectional view of the container assembly of FIG. 1, taken from within portion 14 of FIG. 13;

FIG. 15 is a cross-sectional view of the container assembly of FIG. 1, taken along line Z-Z of FIG. 1, wherein the cap is positioned relative to the container in a locked configuration;

FIG. 16 is a magnified top perspective, cross-sectional view of the container assembly of FIG. 1, taken from within portion 16 of FIG. 15;

FIG. 17 is a magnified top perspective view of the container assembly of FIG. 1, wherein the cap is partially transparent to show a container rotation-stop lug of container threads of the container and a cap rotation-stop lug of cap threads of the cap in a locked configuration; and

FIG. 18 is a magnified top perspective, cross-sectional view of the container assembly of FIG. 1, taken along line Z-Z of FIG. 1, showing interaction of the cap and closure of FIG. 17 in the locked configuration.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right,” “left,” “lower,” and “upper” designate directions in the drawings to which reference is made. The words “inwardly” or “distally” and “outwardly” or “proximally” refer to directions toward and away from, respectively, the geometric center or orientation of the device and related parts thereof. The terminology includes the above-listed words, derivatives thereof and words of similar import.

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

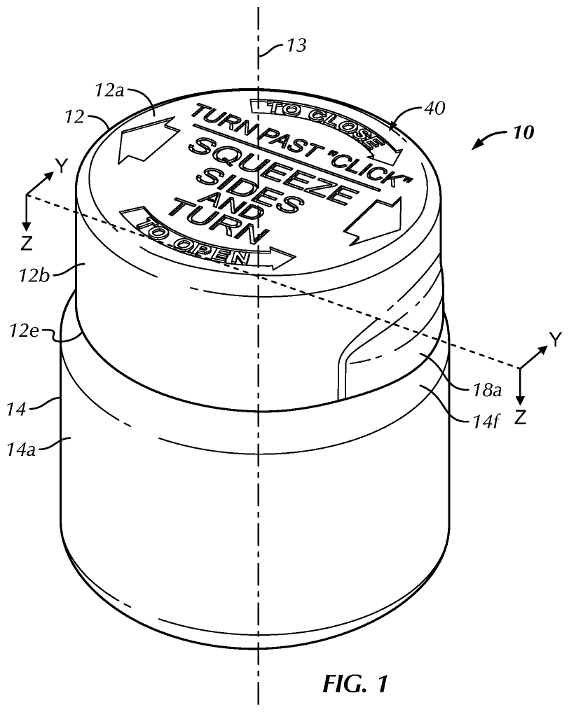

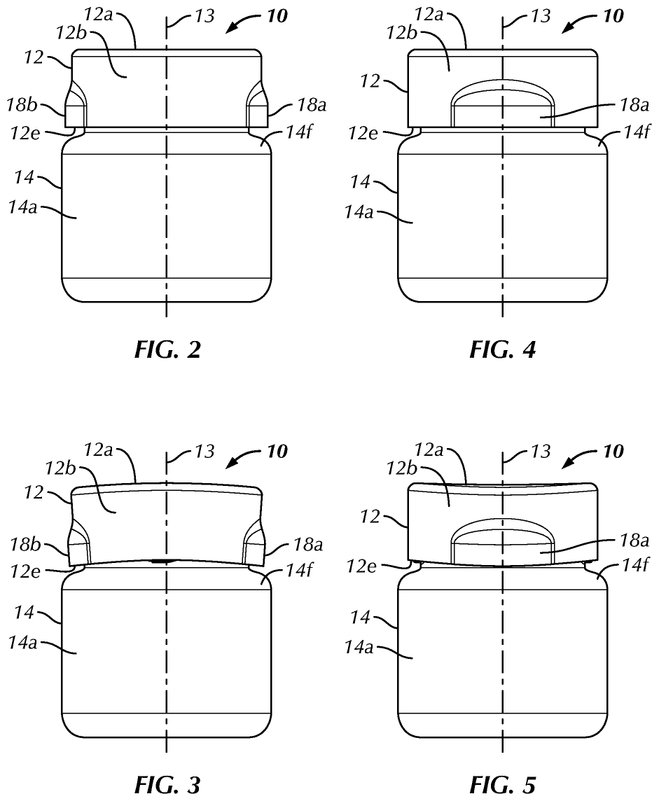

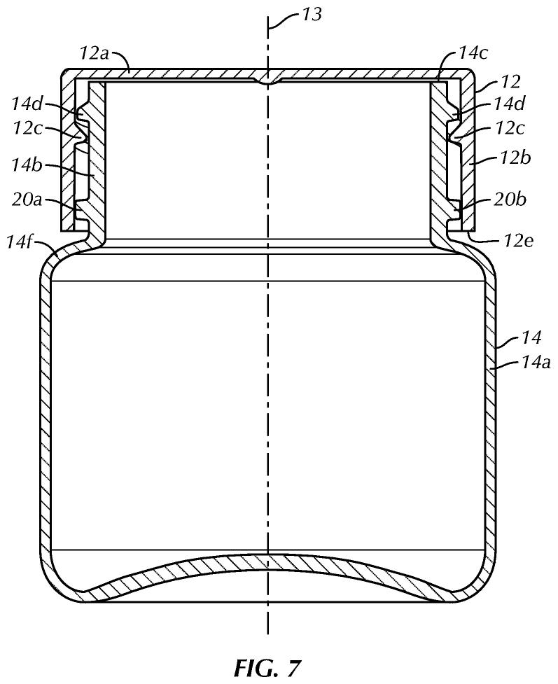

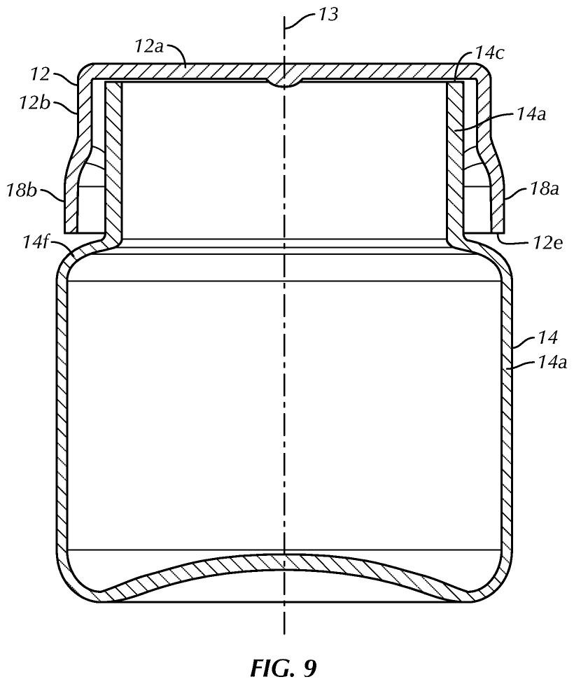

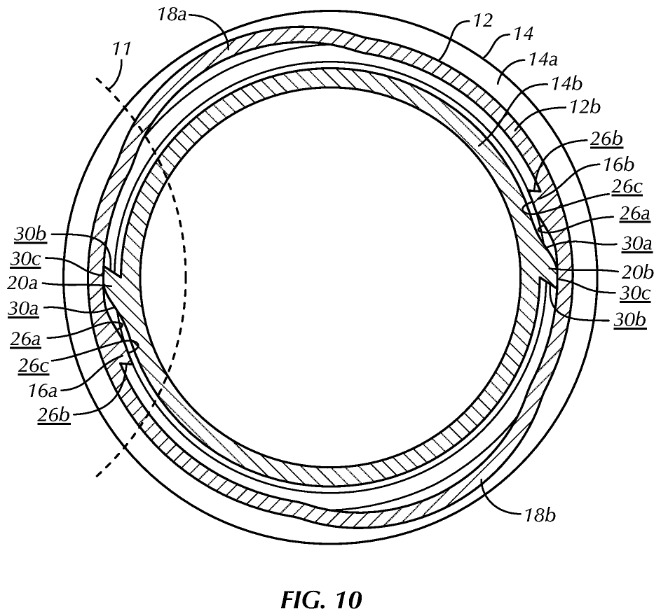

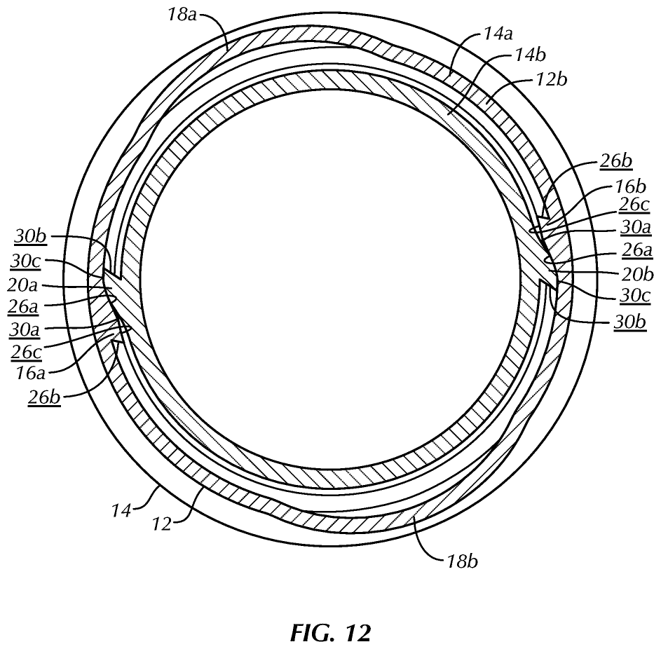

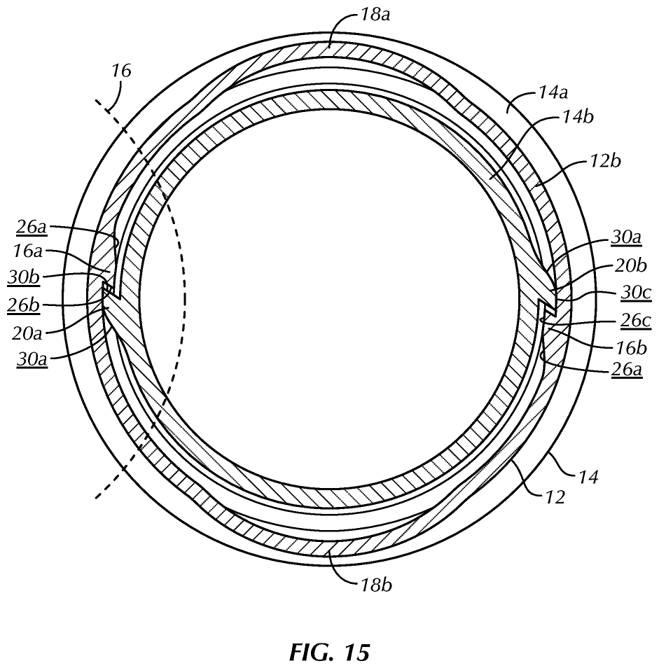

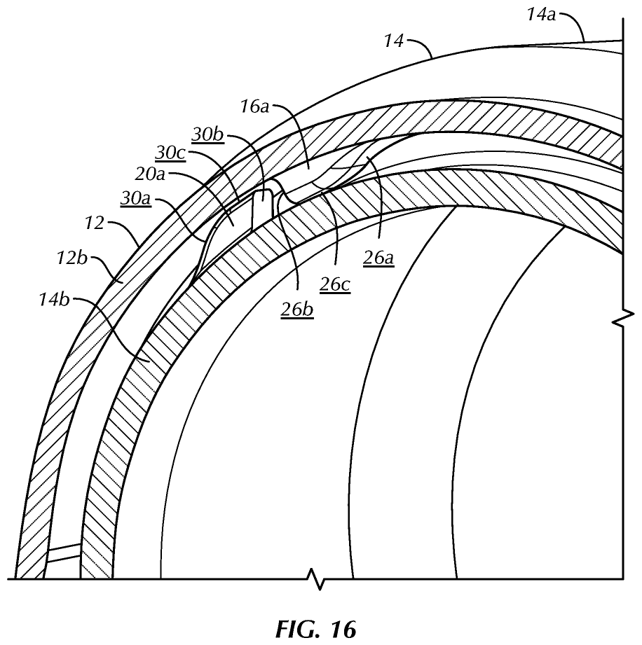

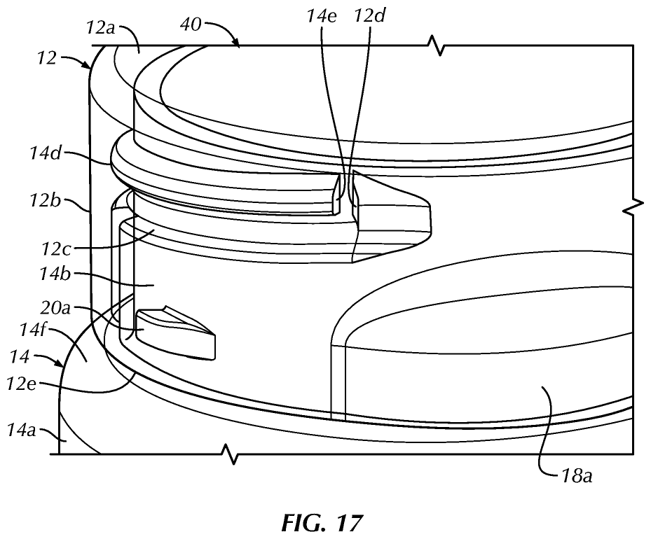

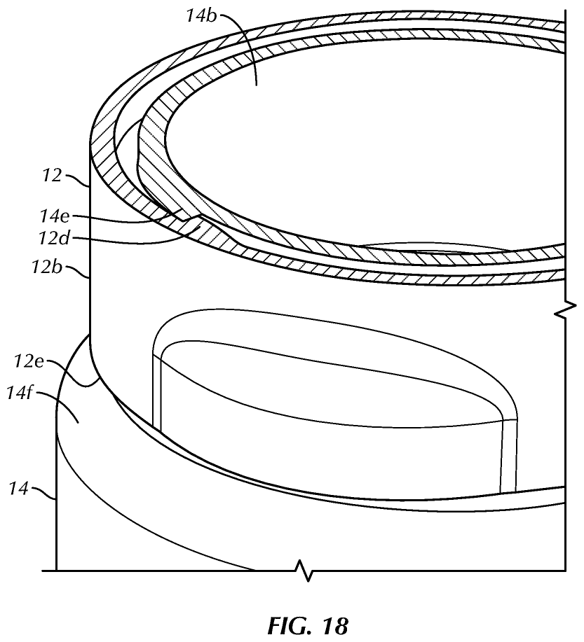

Referring to FIGS. 1-18, the preferred invention is directed to a child resistant, lightweight container or closure assembly, generally designated 10, including a cap 12 and a container 14. In an assembled configuration, the cap 12 and the container 14 define a longitudinal axis 13 that extends substantially centrally through the generally cylindrically-shaped skirt 12b of the cap 12 and body 14a of the container 14 (FIGS. 1-5 and 7-9). The child resistant, lightweight container or closure assembly 10 is operated by squeezing opposing sides of the cap 12 toward the longitudinal axis 13 to open the container assembly 10 or to permit an opening rotation of the cap 12 relative to the container 14 from a locked configuration (FIGS. 15 and 16), preferably by squeezing the cap 12 at opposing first and second cap bulges 18a, 18b, as will be described in greater detail below. The cap 12 includes a top 12a and the skirt 12b and the container 14 includes the body 14a and a neck 14b. The preferred container assembly 10 includes the cap 12 that has cap threads 12c, first and second cap locking lugs 16a, 16b, cap rotation-stop lugs 12d and first and the second bulges 18a, 18b on either side of the closure or cap 12 that bulge outwardly as part of the skirt 12b and these features are preferably, integrally formed or co-molded with the cap 12.

The cap threads 12c are preferably positioned proximate the top 12a and the first and second cap locking lugs 16a, 16b and the first and second bulges 18a, 18b are preferably positioned proximate a terminal end 12e of the skirt 12b. The cap threads 12c of the preferred embodiment are comprised of two opposing cap threads 12c, preferably quarter-turn threads, extending inwardly from the skirt 12b on opposing sides of the skirt 12b. The cap threads 12c preferably have the cap rotation stop lug 12d located at the trailing end of each of the cap threads 12c. The cap rotation-stop lug 12d has a generally flat vertical surface that extends inwardly from the skirt 12b and radially from the longitudinal axis 13. The preferred cap threads 12c are approximately quarter-turn threads 12c that generally fully engage or disengage upon rotation of the cap 12 relative to the container 14 following one-quarter turn. The preferred container or closure assembly 10 is not limited to including the cap thread 12c shown in the appended drawings and may include nearly any number of thread starts, as would be apparent to one having ordinary skill in the art based upon a review of the present disclosure.

The first and second bulges 18a, 18b preferably extend radially outwardly relative to the longitudinal axis 13 in the assembled configuration. The skirt 12b extends substantially perpendicularly and downwardly from the top 12a and has a ring or cylindrical-shape in the preferred embodiment with the top 12a being generally circular. The first bulge 18a is positioned opposite the second bulge 18b on the cap 12 and the first and second bulges 18a, 18b are co-molded or integrally formed with the skirt 12b. The first and second cap lugs 16a, 16b extend radially inwardly from the skirt 12b toward the longitudinal axis 13 in the assembled configuration. The first cap lug 16a is positioned opposite the second cap lug 16b on the skirt 12b or is spaced approximately one hundred eighty degrees from the second cap lug 16b on the skirt 12b relative to the longitudinal axis 13. The first and second cap lugs 16a, 16b are spaced from the first and second bulges 18a, 18b, preferably at approximately ninety degree angles relative to the longitudinal axis 13 on the skirt 12b, such that the first cap lug 16a is spaced from both the first and second bulges 18a, 18b at approximately ninety degrees at opposite sides of the first cap lug 16a and the second cap lug 16b is spaced from both the first and second bulges 18a, 18b at approximately ninety degrees relative to the longitudinal axis 13 at opposite sides of the second cap lug 16b. In the preferred embodiment, the first cap lug 16a is substantially equally spaced between the first and second bulges 18a, 18b and the second cap lug 16b is substantially equally spaced between the first and second bulges 18a, 18b on opposite sides of the skirt 12b. The first and second cap lugs 16a, 16b are not limited to being equally spaced from the first and second bulges 18a, 18b, but are preferably so spaced to maximize the deflection of the first and second cap lugs 16a, 16b radially outwardly in a squeezed configuration, as is described in greater detail below.

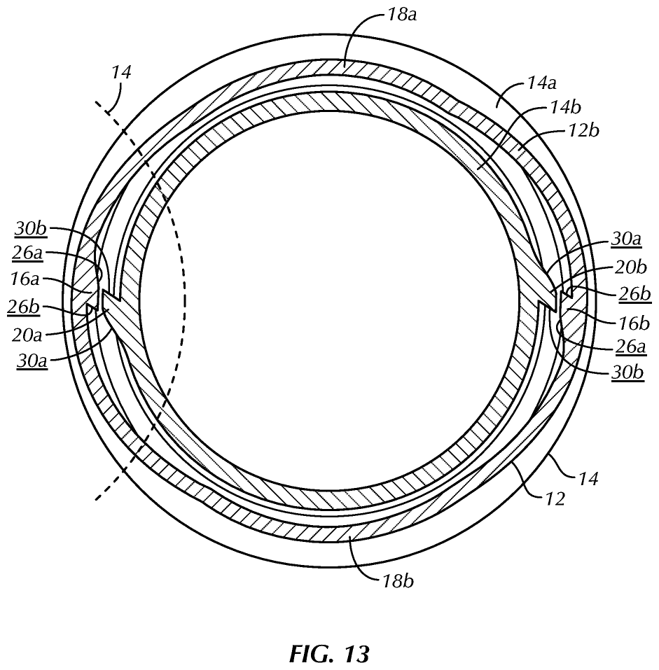

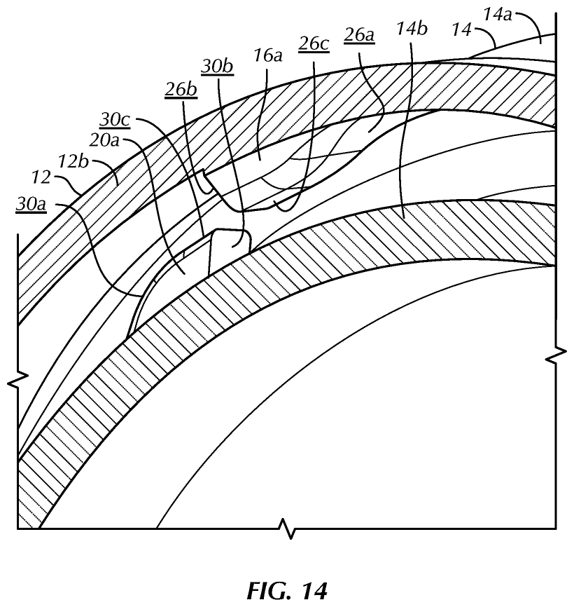

In the preferred embodiment, the first and second cap lugs 16a, 16b and the first and second bulges 18a, 18b are positioned proximate a terminal end 12e of the skirt 12b. The terminal end or open end 12e of the skirt 12b is spaced from the top 12a and is positioned near a shoulder 14f of the container 14 when the cap 12 is mounted to the container 14 in a locked configuration. The first and second cap lugs 16a, 16b and the first and second bulges 18a, 18b are preferably positioned proximate the terminal end 12e to facilitate radial flexing and elastic deformation of the terminal end 12e and the first and second bulges 18a, 18b relative to the top 12a and the neck 14b to operate the container assembly 10, as is described herein. In contrast, the cap threads 12c are positioned proximate the top 12a such that squeezing the first and second bulges 18a, 18b or orienting the cap 12 in the squeezed configuration (FIGS. 13 and 14) to elastically deform the skirt 12b near the first and second cap lugs 16a, 16b has limited impact on the positioning of the cap threads 12c.

The container 14 has the body 14a and the narrowed neck 14b extending from the body 14a that is separated from the body 14a by the shoulder 14f. The neck 14b defines a mouth 14c at a top end through which materials or contents for storage may be inserted into the body 14a or a storage cavity within the body 14a. The neck 14b also includes container threads 14d extending radially outwardly therefrom. The container threads 14d of the preferred embodiment are comprised of two opposing container threads 14d extending outwardly from the neck 14b on opposing sides of the neck 14b. The preferred container threads 14d are approximately quarter-turn threads 14d that generally fully engage or disengage upon rotation of the cap 12 relative to the container 14 following one-quarter turn of the cap 12 relative to the container 14. The container threads 14d engage and disengage with the cap threads 12c to facilitate this preferably one-quarter turn engagement and disengagement, although the cap threads 12c and container threads 14d are not so limited and may be comprised of any threads or connection mechanism that is able to engage and disengage the cap 12 from the container 14 and permits the additional functions of the preferred container assembly 10 described herein.

The container threads 14d each have a flat surface or container rotation-stop lug 14e located at the leading edge that interacts with the cap rotation-stop lugs 12d. The container rotation-stop lug 14e is generally vertical and extends outwardly from the container neck 14b and radially from the longitudinal axis 13. The container rotation-stop lugs 14e interact with the cap rotation-stop lugs 12d to block forward rotation of the cap 12 beyond a certain point relative to the container 14 in a locked configuration, wherein the cap 12 is in a relaxed configuration. The cap and container rotation-stop lugs 12d, 14e are preferably located at the leading ends of the container threads 14d and the trailing ends of the cap threads 12c, respectively, although they are not so limited in position or number and can be located at any location on the container 14 and cap 12 so long as the cap and container rotation-stop lugs 12d, 14e limit over-rotation of the cap 12 relative to the container 14 in the tightening direction of the container assembly 10.

The container 14 includes first and second container lugs 20a, 20b that extend radially outwardly from the neck 14b. The first container lug 20a is positioned opposite the second container lug 20b on the neck 14b or approximately one hundred eighty degrees rotationally relative to the longitudinal axis 13. The first and second cap lugs 16a, 16b interact with the first and second container lugs 20a, 20b to block reverse or opening pivoting of the cap 12 relative to the container 14 in a locked configuration, wherein the cap 12 is in a relaxed configuration.

The cap 12 and container 14 are preferably both constructed of a polymeric material such as polypropylene (PP), though other materials such as low or high density polyethylene, polyvinyl chloride (PVC), polystyrene, polyester terephthalate (PET), nylon, and the like may be similarly used. The cap 12 and container 14 are preferably individually molded with their herein described features co-molded with the cap 12 and the container 14, respectively.

The container assembly 10 is relatively easy to open and close for an individual having limited dexterity with their fingers and is also preferably child-resistant. Squeezing on the opposing first and second bulges 18a, 18b releases the first and second cap lugs 16a, 16b from the relaxed configuration, such that the first and second cap lugs 16a, 16b flex outwardly relative to the longitudinal axis 13. This flexing of the first and second cap lugs 16a, 16b outwardly clears the first and second cap lugs 16a, 16b relative to the first and second container lugs 20a, 20b in a mounted or assembled configuration, such that the cap 12 is rotatable relative to the container 14 for removal of the cap 12 from the container 14. The container assembly 10 can be opened relatively easily by squeezing the cap 12 at the first and second bulges 18a, 18b toward each other, thereby moving or flexing the first and second cap lugs 16a, 16b outwardly away from the first and second container lugs 20a, 20b and simultaneously pivoting or rotating the cap 12 relative to the container 14. This rotation is preferably a quarter-turn of the cap 12 relative to the container 14 about the longitudinal axis 13 on the quarter-turn cap threads 12c and container thread 14d. The preferred cap 12 has only one wall or skirt 12b, unlike many of other known closures that use a similar squeezing technique, but require two adjacent walls at the skirt to achieve the unlocking necessary to open the container assembly.

The first and second container lugs 20a, 20b are positioned near a bottom of the neck 14b proximate a shoulder 14f of the container 14. The first and second container lugs 20a, 20b are preferably positioned near or proximate the shoulder 14f at the bottom of the neck 14b for interaction with the first and second cap lugs 16a, 16b in operation. The first and second container lugs 20a, 20b are not limited to being positioned proximate the shoulder 14f, but are preferably spaced from the mouth 14c at a sufficient distance for interaction with the first and second cap lugs 16a, 16b, which are preferably spaced from the top 12a.

In the preferred embodiment, an inwardly directed force is applied to the first and second bulges 18a, 18b to urge the first and second cap lugs 16a, 16b radially outwardly in a release configuration or the squeezed configuration (FIGS. 14 and 15). The first and second bulges 18a, 18b are squeezed radially inwardly to disengage the first and second cap lugs 16a, 16b from the first and second container lugs 20a, 20b in the release configuration such that the cap 12 is pivotable or rotatable relative to the container 14 in an opening direction, which is preferably counterclockwise when viewed from the top and as is shown by the indicia 40 on the top 12a, on the cap threads 12c and container threads 14d.

In the preferred embodiment, the skirt 12b is comprised of a single wall, thereby producing an economical closure of relatively limited weight. The single wall skirt 12b is relatively economical and has limited weight when compared to known double-walled closures or caps that include more material than the single wall skirt 12b of the preferred embodiment, because the prior art caps required the double-walled structure. The cap 12 and container 14 are preferably very easy to operate both for opening and closing, wherein the cap 12 is squeezed at the first and second bulges 18a, 18b to release the cap 12 from the locked configuration and may be rotated on the cap threads 12c and container threads 14d in a conventional manner until the container is open. The cap and container 14 are also preferably child resistant.

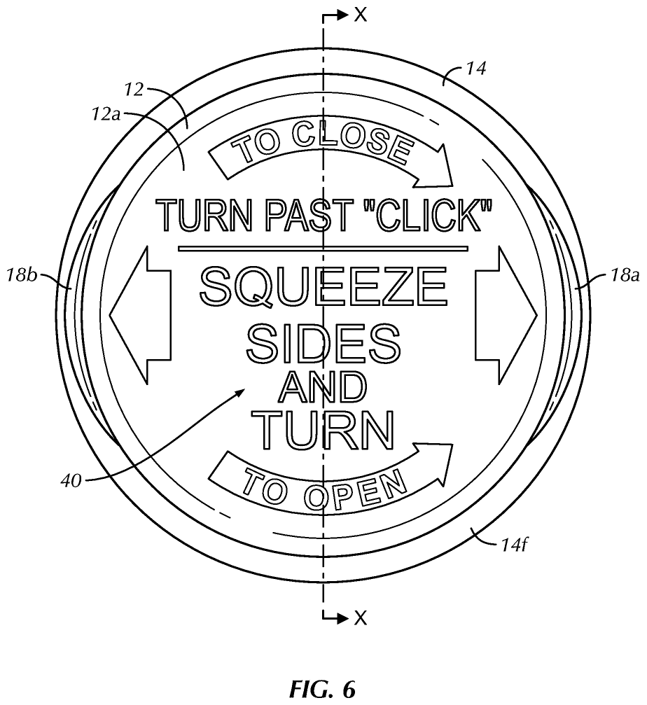

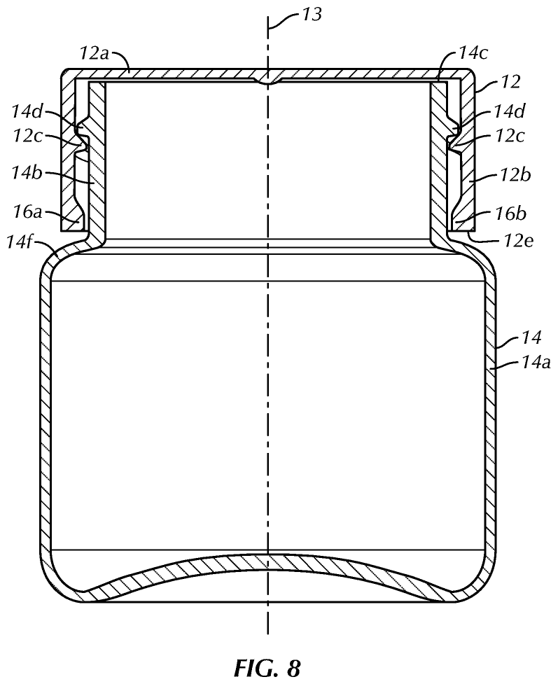

To replace the cap 12 onto the container 14, the cap 12 is positioned over the mouth 14c of the container 14 by urging the top 12a toward the mouth 14c and rotating the cap 12, preferably in the clockwise direction when viewed from the top (FIG. 6), until a clearly audible click is heard, indicating that the cap 12 is in the secure and closed position. The audible click is created when the first and second cap locking lugs 16a, 16b clear the locking surfaces 30b of the container lugs 20a, 20b such that the skirt 12b flexes from a squeezed configuration (FIGS. 3, 5, 13 and 14) or a configuration where the first and second cap locking lugs 16a, 16b slide over the first and second container lugs 20a, 20b into its relaxed configuration (FIGS. 1, 2 and 7-9), wherein the first and second cap locking lugs 16a, 16b are positioned adjacent to an outer surface of the neck 14b. As is specifically seen in FIG. 8, the first and second cap locking lugs 16a, 16b are positioned adjacent the outer surface of the neck 14b in the relaxed configuration and the first and second cap locking lugs 16a, 16b preferably create the audible click by impacting the outer surface of the neck 14b or inner surface of the skirt 12b contacting the container lugs 20a, 20b after the first and second cap lugs 16a, 16b snap over and clear the container lugs 20a, 20b. After the audible click is produced, further clockwise rotation of the cap 12 is prevented or limited relative to the container 14 by the flat surface of the cap rotation-stop lugs 12d making contact with the container rotation-stop lugs 14e while the container assembly 10 is in the locked configuration. In the locked configuration, the closure assembly 10 is generally child resistant, limiting access to contents within the container 14. For example, the container 14 may be filled with contents, such as medication, tablets, caplets or other forms of medication, including a powder for drug reconstitution

The preferred container assembly 10 does not require any extraordinary movements to close or open the closure 12 on the container 14, but only squeezing the first and second bulges 18a, 18b and pivoting the cap 12 relative to the container 14 a relatively short distance, preferably a quarter-turn relative to the longitudinal axis or ninety degrees, to allow the first and second container lugs 20a, 20b to clear the first and second cap locking lugs 16a, 16b during counterclockwise pivoting of the cap 12 relative to the container 14 on the cap and container threads 12c, 14d. The cap 12 preferably provides an audible click when rotated onto and closed onto the container 14 in the locked configuration that indicates to the user that the cap 12 is secure and in the locked configuration. The container assembly 10 preferably does not depend on a minimum torque to achieve child resistance for opening.

The container 14 includes the opposing and protruding container lugs 20a, 20b extending from the neck 14b that are co-molded with the container 14. The container lugs 20a, 20b provide the locking mechanism that assists in providing the audible click when the cap 12 is applied to the container 14, as described above. The cap 12 includes the counterpart opposing first and second cap lugs 16a, 16b that will hit the container lugs 20a, 20b when being opened or attempting to be opened without squeezing the first and second bulges 18a, 18b. The cap lugs 16a, 16b are spread apart when force is applied inwardly to the sidewalls of the closure at the bulges 18a, 18b, thereby causing the cap lugs 16a, 16b to flex to extend outwardly relative to the longitudinal axis 13.

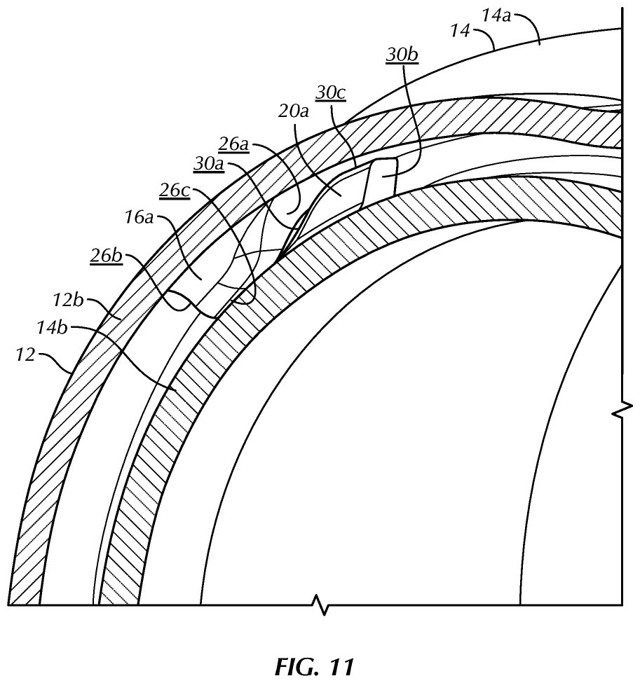

Referring to FIGS. 11-17, the preferred first and second cap lugs 16a, 16b and the first and second container lugs 20a, 20b have a hump-like shape when viewed from their side (e.g. FIG. 11). The preferred first and second cap lugs 16a, 16b include cap ramp surfaces 26a, cap locking surfaces 26b and cap lug peak surfaces 26c. The preferred first and second container lugs 20a, 20b include container ramp surfaces 30a, container locking surfaces 30b and container lug peak surfaces 30c. The first and second cap and container lugs 16a, 16b, 20a, 20b are not limited to having the shapes and configurations shown in the attached drawings, but these shapes are preferred for manufacturing and the function of these components, as is described herein.

In use, the cap 12 is positioned over the mouth 14c such that the cap threads 12c engage the container threads 14d and the cap 12 is pivoted or rotated relative to the container 14 in the closing direction, preferably as is indicated by indicia 40 on the top 12a in a clockwise direction when viewed from the top. As the cap 12 is rotated in the closing direction with the threads 12c, 14d engaged, the cap ramp surfaces 26a approach and subsequently engage the container ramp surfaces 30a (FIGS. 11-13). The ramp-like shape of the cap and container ramp surfaces 26a, 30a and continued rotation of the cap 12 relative to the container 14 in the closing direction causes the skirt 12b to flex outwardly at the first and second cap locking lugs 16a, 16b and inwardly at the bulges 18a, 18b with a majority of the flexing occurring near the terminal end 12e of the skirt 12. Proximate the top 12a, flexing is relatively minimal and the cap and container threads 12c, 14d remain engaged. The skirt 12b is configured to flex, such that a reasonable amount of rotational force applied by the user in the closing direction facilitates the flexing and sliding of the cap and container ramp surfaces 26a, 30a on each other until the cap and container lug peak surfaces 26c, 30c are in contact. Continued rotating of the cap 12 relative to the container 14 in the closing direction results in the cap and container lug peak surfaces 26c, 30c passing each other and the skirt 12b causing the first and second cap locking lugs 16a, 16b to snap inwardly and the first and second bulges 18a, 18b to snap outwardly. This return of the skirt 12b to its generally cylindrical relaxed configuration creates an audible snap, notifying the user that the cap 12 is in the locked configuration with the cap locking surfaces 26b of the first and second cap lugs 16a facing the container locking surfaces 30b of the first and second container lugs 20a, 20b in the locked configuration. The cap and container locking surfaces 26b, 30b, which extend generally perpendicularly relative to the longitudinal axis 13 to slightly toward each other proximate the cap and container lug peak surfaces 26c, 30c generally prevent pivoting of the cap 12 relative to the container 14 in the opening or counterclockwise direction when they are in the locked configuration without squeezing the bulges 18a, 18b.

Attempts to open the container assembly 10 in the locked configuration (FIG. 15) by rotating the cap 12 in the opening direction, preferably the counterclockwise direction when viewed from the top as indicated by the indicia 40 on the top 12a, results in the cap and container locking surfaces 26b, 30b engaging and preventing the opening rotation of the cap 12 relative to the container 14. As was described above, to open the container assembly 10, the cap 12 is squeezed at the first and second bulges 18a, 18b, thereby causing the first and second cap lugs 16a, 16b to extend radially outwardly and the first and second bulges 18a, 18b to move radially inwardly toward the longitudinal axis 13 such that the cap peak surfaces 26c are positioned further radially outwardly from the longitudinal axis 13 than the container ramp surfaces 30b (FIG. 13). The user may then rotate the cap 12 relative to the container 14 in the opening direction without the cap and container locking surfaces 26b, 30b engaging and preventing rotation of the cap 12 relative to the container 14. The cap 12 is preferably rotated approximately one-quarter turn or ninety degrees relative to the container 14 to release the cap and container threads 12c, 14d from each other to remove the cap 12 from the container 14 to gain access to the contents.

In operation, the skirt 12b includes the internal threads 12c that engage the external threads 14d of the container 14. The skirt 12b further includes the cap rotation-stop lugs 12d located at the trailing end of the internal threads 12c that may interact with the container rotation-stop lugs 14e during a closing rotation to prevent over-rotation of the cap 12 relative to the container 14. The skirt 12b also includes the first and second cap lugs 16a, 16b that interact with the first and second container lugs 20a, 20b. Accordingly, the flexible skirt 12b that flexes for opening and closing the container assembly 10 also includes the internal threads 12c for engaging the external threads 14d, the first and second cap lugs 16a, 16b that cooperate with the first and second container lugs 20a, 20b and the cap and container rotation-stop lugs 12d, 14e that prevent over-rotation to facilitate the child resistant function of the preferred container assembly 10. This construction is distinctly different than known double-walled design closure assemblies or known closure assemblies that are significantly taller, wherein the threads of the cap are typically isolated from the component of the cap that is deformed or utilized to facilitate the child resistant locking feature. The skirt 12b of the preferred cap 12 is, accordingly, flexed or deformed in such a way as to deform the shape and position of the internal threads 12c, but only to the extent that they are still functional for engagement with the external threads 14d of the container 14 during use. The configuration of the skirt 12b, including the first and second bulges 18a, 18b positioned near the lower edge of the skirt 12b, the positioning of the internal threads 12c near the top 12a and the positioning of the first and second cap lugs 16a, 16b near the lower edge of the skirt 12b facilitates continued functioning of the internal threads 12c with the external threads 14d and operation of the child resistant features of the container assembly 10.

The shape of the skirt 12b and the bulges 18a, 18b, as well as the positioning of the threads 12c, the first and second cap lugs 16a, 16b and the bulges 18a, 18b facilitates functioning of the preferred container assembly 10, as was described herein. Specifically, positioning the bulges 18a, 18b and the first and second cap lugs 16a, 16b near the lower edge of the skirt 12b permits relatively large radial displacements of the bulges 18a, 18b and the first and second cap lugs 16a, 16b relative to the longitudinal axis 13 and comparatively minimal radial deformation of the internal threads 12c that are positioned near the top 12a. The relatively minimal deformation of the threads 12c facilitates continued functioning and engagement between the internal threads 12c on the skirt 12b and the external threads 14d on the cap 14. Similarly, so that the external threads 14d cooperate and engage the internal threads 12c and the first and second cap lugs 16a, 16b cooperate with the first and second container lugs 20a, 20b, the external threads 14d are positioned near the mouth 14c and the first and second container lugs 20a, 20b are positioned near the base of the neck 14b. In the relaxed configuration, the entire skirt 12b has a generally cylindrical-shape, while in the squeezed configuration, the skirt 12b has a generally cylindrical-shape near the top 12a and an elliptical-shape near the terminal end 12e with the bulges 18a, 18b positioned near the co-vertices of the ellipse and the first and second cap locking lugs 16a, 16b positioned near the opposing vertices of the ellipse.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the appended claims.

1-20. (canceled)

21. A lightweight container assembly wherein an operator squeezes opposing sides toward a longitudinal axis to open the container assembly, the container assembly comprising:
a cap having a top and a skirt extending substantially perpendicularly from the top, the skirt having a first bulge and a second bulge, inner surfaces of the first and second bulges extending radially outwardly a greater distance relative to the longitudinal axis compared to a remainder of an inner surface of the skirt, the first bulge positioned opposite the second bulge on the skirt, the cap also including first and second cap lugs extending inwardly from the skirt, the first cap lug positioned opposite the second cap lug on the skirt and the first and second cap lugs being spaced from the first and second bulges, the first and second cap lugs and the first and second bulges positioned proximate a terminal end of the skirt, the cap including cap threads extending inwardly from the skirt; and
a container having a body and a narrowed neck extending from the body, the neck defining a mouth at a top end of the neck, the container including first and second container lugs extending radially outwardly from the neck, the first container lug positioned opposite the second container lug on the neck, the first and second cap lugs interacting with the first and second container lugs to block pivoting of the cap relative to the container in a locked configuration when the cap is in a relaxed configuration, the container including container threads extending from the neck proximate the mouth that are engaged with the cap threads in the locked configuration

22. The container assembly of claim 21, wherein an inwardly directed force is applied to the first and second bulges to urge the first and second cap lugs radially outwardly in a release configuration.

23. The container assembly of claim 21, wherein the first and second bulges are squeezed radially inwardly to disengage the first and second cap lugs from the first and second container lugs in a release configuration.

24. The container assembly of claim 21, wherein the skirt is comprised of a single wall, thereby producing an economical closure of relatively limited weight.

25. The container assembly of claim 21, wherein the cap and container are easy to operate both for opening and closing.

26. The container assembly of claim 21, wherein the cap and container produce an audible click to alert the operator that the cap is in the locked configuration when the cap moved from a squeezed configuration to a locked configuration when securing the cap to the container.

27. The container assembly of claim 21, wherein the first and second bulges and the first and second cap lugs are positioned proximate a terminal end of the skirt and the first and second container lugs are positioned proximate a shoulder of the container.

28. The container assembly of claim 21, wherein the cap threads are comprised of internal threads positioned proximate the top and the container threads are comprised of external threads positioned proximate the mouth.

29. The container assembly of claim 21, wherein the cap threads include first cap threads and second cap threads, the first cap threads extending radially inwardly from an opposite side of the skirt than the second cap threads.

30. The container assembly of claim 29, wherein the first bulge is positioned between the first and second cap threads and the second bulge is positioned between the first and second cap threads, respectively.

31. The container assembly of claim 29, wherein the first and second cap threads are positioned closer to the top than the first and second cap locking lugs and the first and second bulges.

32. The container assembly of claim 21, wherein the cap and container include rotation-stop lugs that limit overtightening of the cap onto the container.

33. The container assembly of claim 21, wherein the container threads are comprised of external threads, the external threads have a container rotation-stop lug at a leading end of the external threads, the cap threads comprised of internal threads, the internal threads having a cap rotation-stop lug at a trailing end of the internal threads.

34. The container assembly of claim 21, wherein the first and second container lugs each include a container ramp surface, a container locking surface and a container lug peak surface.

35. The container assembly of claim 21, wherein the first and second cap lugs each include a cap ramp surface, a cap locking surface and a cap lug peak surface.

36. A child resistant closure assembly for limiting access to contents, the closure assembly comprising:
a cap having a top and a skirt extending substantially perpendicularly from the top, the skirt being substantially cylindrical and having a first bulge and a second bulge with inner and outer surfaces extending radially outwardly relative to a longitudinal axis further than inner and outer surfaces of the remainder of the substantially cylinrical skirt, the first bulge positioned opposite the second bulge on the skirt, the cap also including first and second cap lugs extending inwardly from the skirt, the first cap lug positioned opposite the second cap lug on the skirt and the first and second cap lugs being spaced from the first and second bulges, the first and second cap lugs and the first and second bulges positioned proximate a terminal end of the skirt, the cap including cap threads extending inwardly from the skirt, the cap threads positioned proximate the top, the first and second cap lugs including cap ramp surfaces, cap locking surfaces and cap lug peak surfaces; and
a container having a body and a narrowed neck extending from the body, the neck defining a mouth at a top end of the neck, the container including first and second container lugs extending radially outwardly from the neck, the first container lug positioned opposite the second container lug on the neck, the first and second container lugs positioned proximate a shoulder of the container and being spaced from the mouth, the first and second container lugs including container ramp surfaces, container locking surfaces and container lug peak surfaces, the first and second cap lugs interacting with the first and second container lugs to block pivoting of the cap relative to the container in a locked configuration when the cap is in a relaxed configuration, the cap locking surface of the first cap lug faces the container locking surface of the first container lug in the locked configuration, the container including container threads extending from the neck proximate the mouth.

37. The closure assembly of claim 36, wherein the first and second container lugs are co-molded with the container from a polymeric material.

38. The closure assembly of claim 36, wherein the first and second cap lugs are co-molded with the cap from a polymeric material.

39. The closure assembly of claim 36, wherein the cap threads and the container threads are quarter-turn threads.

40. The closure assembly of claim 36, wherein the cap lug peak surfaces are positioned radially outwardly relative to container lug peak surfaces in a squeezed configuration
